(19) United States
(12) Patent Application Publication
(10) Pub. No.: US 2024/0053229 A1
(43) Pub. Date: Feb. 15, 2024

(54) PHYSICAL QUANTITY DETECTION DEVICE

(71) Applicant: Hitachi Astemo, Ltd., Hitachinaka-shi, Ibaraki (JP)

(72) Inventors: Fumio YUKI, Hitachinaka-shi (JP); Takeo HOSOKAWA, Hitachinaka-shi (JP); Kenji YOSHIHARA, Hitachinaka-shi (JP); Tsukasa TAKAHASHI, Hitachinaka-shi (JP); Hiroyuki ABE, Hitachinaka-shi (JP)

(73) Assignee: Hitachi Astemo, Ltd., Hitachinaka-shi, Ibaraki (JP)

(21) Appl. No.: 18/269,658

(22) PCT Filed: Aug. 30, 2021
(86) PCT No.: PCT/JP2021/031805

§ 371 Date: Jun. 26, 2023

(30) Foreign Application Priority Data
Mar. 16, 2021 (JP) 2021-042686

(51) Int. Cl. G01M 17/02; B60C 23/04; B60C 23/18; B60C 23/06

(52) U.S. Cl. CPC G01M 17/02; B60C 23/0488; B60C 23/18; B60C 23/064

(57) ABSTRACT

An object of the present invention is to mitigate an influence of a physical quantity other than strain of a tire on a measurement result of a strain sensor and to improve measurement accuracy of the strain sensor. A strain amount detection device according to the present invention calculates an estimation value of a load applied to a tire by using data describing a relationship among an actually measured strain amount, a tire air pressure, a vehicle speed, a tire temperature, and a tire load.

### TECHNICAL FIELD

The present invention relates to a physical quantity detection device that detects a physical quantity acting on a tire.

### BACKGROUND ART

In recent years, toward achievement of automatic driving, development of a tire sensor technology for detecting slipperiness of a road surface, a load applied to a tire, and the like on the basis of information obtained from the tire has been actively carried out in order to provide a safer traveling state. This is to prevent a tire trouble such as a burst due to an overload or the like and a vehicle rollover due to a load imbalance by providing a safer traveling state. In order to construct such a safety control system, it is necessary to accurately detect physical quantities such as a load and an air pressure detected by the tire. For example, a system for notifying a load balance of a four-wheeler is a system for the purpose of preventing an accident such as overturning due to an unbalanced load generated in a truck or the like. For example, in a case of traveling on a curve in a state where a load imbalance of 100 kg is generated for a four-wheeler, there is a possibility of overturning, and it is necessary to measure the load of the four-wheeler with an accuracy of, for example, 10% or less.

By detecting strain deformation of a tire, a tire strain sensor can detect a load acting on the tire and wear of the tire. This is expected to prevent vehicle troubles and improve traveling safety by detecting travel and road surface conditions.

The strain sensor may detect physical quantities (e.g.: vehicle speed, temperature, air pressure, load, and the like) other than strain simultaneously with the strain. Therefore, the detection signal representing the result of the strain sensor detecting the strain may include components caused by these physical quantities. The detection accuracy of the strain is reduced by components caused by those physical quantities other than the strain.

PTL 1 below describes a technique related to a strain sensor. With an issue ‘To provide a system and method for estimating a load bearing on a vehicle tire.’, the literature discloses a technique ‘There is provided a system and method for estimating a load bearing on a vehicle tire. The system includes: an air pressure measuring sensor attached to the tire for measuring a tire cavity air pressure level; and one or two or more piezofilm deformation measuring sensors mounted on the tire sidewalls. The deformation measuring sensor generates within the tire footprint a deformation signal having signal power level indicative of a level of sidewall deformation within the footprint contact patch. Power-to-load maps adjusted for tire air pressure are generated and stored for the tire, the maps correlating a range of load levels to a range of signal power levels whereby operatively enabling a load level to be identified for each signal power level on an air pressure adjusted basis.’ (see Abstract).

### CITATION LIST

### Patent Literature

PTL 1: JP 2014-054978 A

### SUMMARY OF INVENTION

### Technical Problem

In the technique described in PTL 1, in view of the fact that the change in the tire air pressure changes the signal amplitude of the load sensor, the signal power level of the load sensor is corrected using the tire air pressure measured by the air pressure measuring sensor. However, the detection signal of the load sensor may include a component caused by a physical quantity other than air pressure. Therefore, it is considered that the technique described in the literature has room for improvement in detection accuracy of the load sensor.

The present invention has been made in view of the above problems, and an object is to mitigate an influence of a physical quantity other than strain of a tire on a measurement result of a strain sensor and to improve measurement accuracy of the strain sensor.

### Solution to Problem

A strain amount detection device according to the present invention calculates an estimation value of a load applied to a tire by using data describing a relationship among an actually measured strain amount, a tire air pressure, a vehicle speed, a tire temperature, and a tire load.

### Advantageous Effects of Invention

According to the strain amount detection device according to the present invention, it is possible to mitigate an influence of a physical quantity other than strain of a tire on a measurement result of a strain sensor and to improve measurement accuracy of the strain sensor.

### BRIEF DESCRIPTION OF DRAWINGS

FIG. 1 is a block diagram illustrating a configuration of a physical quantity detection device 1 according to a first embodiment.

FIG. 2 is a flowchart explaining a procedure in which a calculation unit 15 calculates a load acting on a tire.

FIG. 3A is an example of data acquired by the calculation unit 15 in S201.

FIG. 3B is data indicating a change in a strain measurement signal when the tire air pressure changes under a reference vehicle speed, a reference load, and a reference temperature.

FIG. 4 is an example of data created by the calculation unit 15 in S202.

FIG. 5 is an example of data acquired by the calculation unit 15 in S203.

FIG. 6 is a schematic diagram explaining a procedure in which the calculation unit 15 obtains a load in S204.

FIG. 7 is a block diagram illustrating a configuration of the physical quantity detection device 1 according to a second embodiment.

FIG. 8 is a block diagram illustrating a configuration of the physical quantity detection device 1 according to a third embodiment.

FIG. 9 is a block diagram illustrating a configuration of the physical quantity detection device 1 according to a fourth embodiment.

FIG. 10 is a block diagram illustrating a configuration of the physical quantity detection device 1 according to a fifth embodiment.

FIG. 11 illustrates a relationship between a strain signal and a tire state.

FIG. 12 illustrates a typical strain signal waveform.

FIG. 13 illustrates an error occurrence mechanism due to parameter variation.

FIG. 14 illustrates a conventional load calculation estimation result.

FIG. 15 illustrates an effect of load detection based on a result of simulation with a load extraction model created by MATLAB Simulink.

FIG. 16 illustrates vehicle speed sensitivity of load detection.

### DESCRIPTION OF EMBODIMENTS

### Problems of Prior Art

The inventors have considered the degree of influence of a temperature, a vehicle speed, and an air pressure signal mixed in a strain signal on load extraction calculation accuracy.

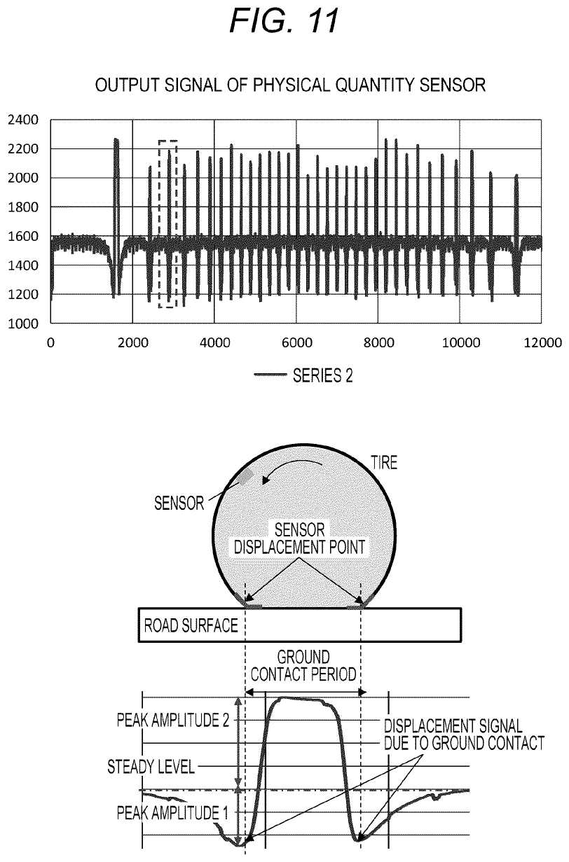

The upper part in FIG. 11 illustrates a periodic waveform of a strain signal, and the lower part in FIG. 11 illustrates a relationship between the strain signal and the tire state. First, a relationship between an output signal of a physical quantity sensor mounted to a tire and the tire state will be described. The physical quantity sensor disposed in the tire outputs a signal that changes depending on the state of the rotating tire. A peak 1 appears at a displacement point where the sensor comes into contact with or separates from the road surface, a peak 2 appears in a state where the sensor is in ground contact with the road surface, and a steady level is maintained when the sensor is not in ground contact with the road surface. That is, the peak 1 and the peak 2 change depending on the detected physical quantity.

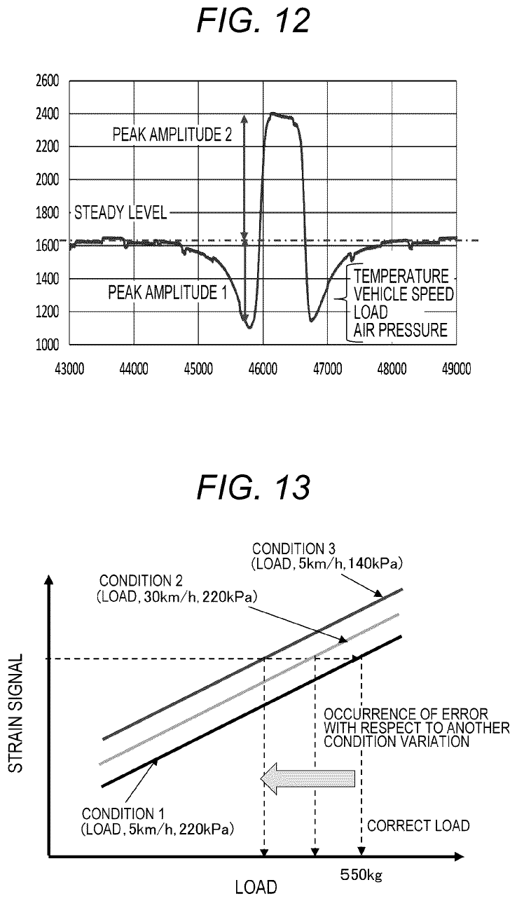

FIG. 12 illustrates a typical strain signal waveform. In confirming the detection sensitivity of the sensor, parameters related to the tire and traveling conditions have been confirmed. The parameters of the tire are considered to be the air pressure, the temperature, and the tire wear, and the traveling conditions are considered to be the vehicle speed and the number of occupants (load). For example, confirmation of the dependence of the air pressure, the temperature, the vehicle speed, and the load has indicated that all of them have sensitivity, and the air pressure, the temperature, the vehicle speed, and the load are mixed in the peak 1 and the peak 2 of the strain signal.

FIG. 13 illustrates an error occurrence mechanism due to parameter variation. The influence of the mixed signal described in FIG. 12 on load detection has been confirmed according to FIG. 13. FIG. 13 is an image diagram of a sensitivity graph where the vertical axis represents the strain signal and the horizontal axis represents the load. As can be seen from the graph of a condition 1 (vehicle speed=5 km/h and air pressure=220 kPa), the load and the strain signal change linearly, and the load can be detected by the magnitude of the strain signal. On the other hand, as in a condition 2 (vehicle speed=30 km/h and air pressure=220 kPa) and a condition 3 (vehicle speed=5 km/h and air pressure=140 kPa), a difference occurs in sensitivity characteristics between the load and the strain signal due to a difference in the vehicle speed and the air pressure, and when the load is obtained with the strain signal with reference to the condition 1, it is found that the load becomes small in the conditions 2 and 3 with respect to 550 kg of the condition 1, and an error occurs when the load is obtained with the mixed signal.

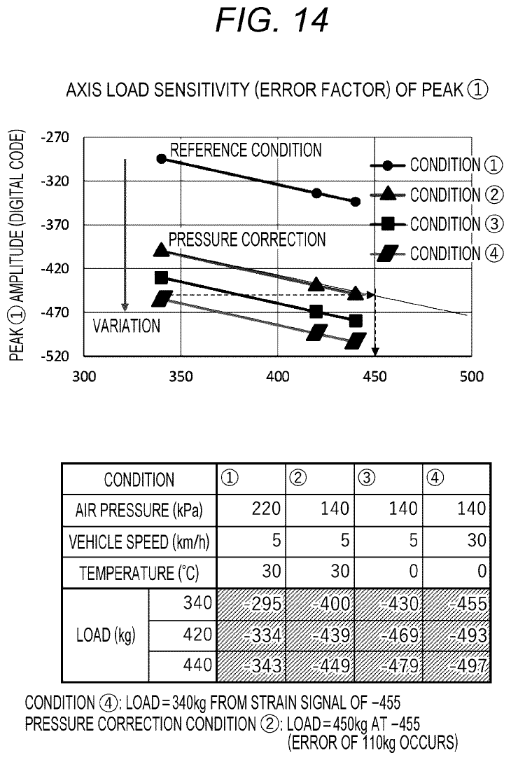

FIG. 14 illustrates a conventional load calculation estimation result. It is a result calculated from the sensitivity characteristic of each parameter of the load obtained from an experiment with an actual vehicle. FIG. 14 illustrates the sensitivity characteristic between the load and the strain signal (peak 1) when the air pressure is set to 140 kPa in the condition 2, the air pressure is set to 140 kPa and the temperature is set to 0° C. in the condition 3, and the air pressure is set to 140 kPa, the temperature is set to 0° C., and the vehicle speed is set to 30 km/h in the condition 4 with respect to the reference condition 1 (temperature=30° C., vehicle speed=5 km/h, and air pressure=220 kPa). It can be seen that the difference in sensitivity widens as the condition variations are sequentially added to the condition 1 such as the air pressure, the temperature, and the vehicle speed. For example, in the characteristic when the air pressure in the condition 2 is changed, the load is 340 kg when the strain signal expressed in the digital code is −400 (condition 1: −295). In the case of extracting the load by correcting and calculating only the air pressure, the sensitivity characteristic varies as in the conditions 3 and 4 with respect to the condition 2, and thus the load corresponding to the sensitivity characteristic of the condition 2 at the time of the strain signal −455 indicating 340 kg in the condition 4 becomes 450 kg, which has an error as large as 32%.

### First Embodiment

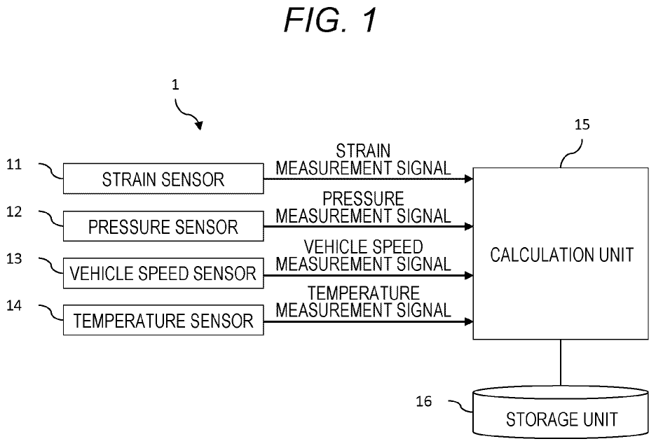

FIG. 1 is a block diagram illustrating the configuration of the physical quantity detection device 1 according to the first embodiment of the present invention. The physical quantity detection device 1 is a device that detects a physical quantity acting on a tire mounted on a vehicle. The physical quantity detection device 1 includes a strain sensor 11, a pressure sensor 12, a vehicle speed sensor 13, a temperature sensor 14, the calculation unit 15, and a storage unit 16.

The strain sensor 11 is mounted to, for example, an inner wall surface of a tire, detects the strain amount of the tire, and outputs a strain measurement signal indicating the result. The pressure sensor 12 measures the air pressure of the tire and outputs a pressure measurement signal indicating the result. The vehicle speed sensor 13 detects the vehicle speed of the vehicle using, for example, the number of revolutions of the tire or the like, and outputs a vehicle speed measurement signal indicating the result. The temperature sensor 14 detects the temperature of the tire and outputs a temperature measurement signal indicating the result.

The calculation unit 15 calculates a load acting on the tire using the measurement signal output from each sensor. The calculation procedure will be described later. The storage unit 16 stores data describing the relationship between the physical quantity measured by each sensor and the load acting on the tire. A specific example of the data will be described later.

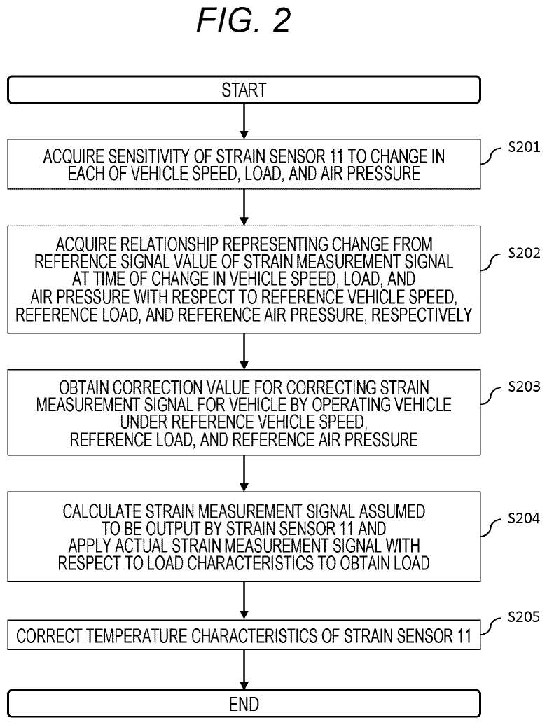

FIG. 2 is a flowchart explaining the procedure in which the calculation unit 15 calculates a load acting on the tire. Each step of FIG. 2 will be described below.

### (FIG. 2: Step S201)

The calculation unit 15 acquires the sensitivity of the strain sensor 11 to a change of each of the vehicle speed, the load, and the air pressure. A specific example of the present step will be described later. The present step has a significance as a preparation for calculating an assumption value of the strain measurement signal with respect to actual measurement values of the vehicle speed, the load, and the air pressure. The assumption value of the strain measurement signal will be described later. The present step is desirably performed under a reference temperature that defines the standard specifications of the strain sensor 11, but a result of performing the present step under a temperature other than the reference temperature may be converted into a value corresponding to the reference temperature.

### (FIG. 2: Step S202)

The calculation unit 15 acquires a relationship representing a change from the reference signal value of the strain measurement signal when the vehicle speed, the load, and the air pressure change with respect to the reference vehicle speed, the reference load, and the reference air pressure, respectively, and stores data describing the result in the storage unit 16. A specific example of the present step will be described later. The present step has a significance in expressing the change in the strain measurement signal when the vehicle speed, the load, and the air pressure change using a difference from the reference vehicle speed, the reference load, and the reference air pressure, respectively, and a change from the reference signal value.

### (FIG. 2: Step S202: Supplement)

The change in the strain measurement signal when the vehicle speed, the load, and the air pressure change is not necessarily expressed using the difference from the reference vehicle speed, the reference load, and the reference air pressure, respectively, and the difference from the reference signal value. However, since the absolute value of the signal value is different for each vehicle type and tire type, it is necessary to create the same data as in the present step in advance for each absolute value, and the data amount greatly increases. Therefore, in the present embodiment, the data amount is suppressed by describing the data using the difference from the reference value together with step S203 described later.

### (FIG. 2: Step S203)

By operating a vehicle mounted with the physical quantity detection device 1 under the reference vehicle speed, the reference load, and the reference air pressure, the calculation unit 15 acquires the amplitude of the strain measurement signal in the vehicle, and stores data describing the result in the storage unit 16. The data acquired in S202 is a typical value acquired for each combination of the vehicle type and the tire type, and the signal value in the actual vehicle may be different from this data. Therefore, in the present step, by obtaining the amplitude of the strain measurement signal of the actual vehicle, a correction value for causing the data of S202 to correspond to the strain measurement signal of the vehicle is obtained. A specific example of the present step will be described later.

### (FIG. 2: Step S204)

The calculation unit 15 calculates a strain measurement signal assumed to be output by the strain sensor 11. This strain measurement signal includes components generated by the vehicle speed, the air pressure, and the load. The calculation unit 15 can calculate the assumption value of the strain measurement signal by individually calculating and adding up these. The calculation unit 15 obtains a load acting on the tire by applying the strain measurement signal actually output by the strain sensor 11 to the load characteristic of the strain measurement signal obtained by calculation. Details of the present step will be described later.

### (FIG. 2: Step S205)

The calculation unit 15 corrects the temperature characteristic of the strain sensor 11. The strain sensor 11 can include, for example, an element whose electric resistance changes according to a force applied to a strain element. The strain measurement signal output from the strain sensor 11 may vary depending on the temperature of the element even when the same strain is measured. Therefore, the calculation unit 15 holds in advance data describing a relationship (temperature characteristic) between the variation and the temperature, and corrects the strain measurement signal according to this.

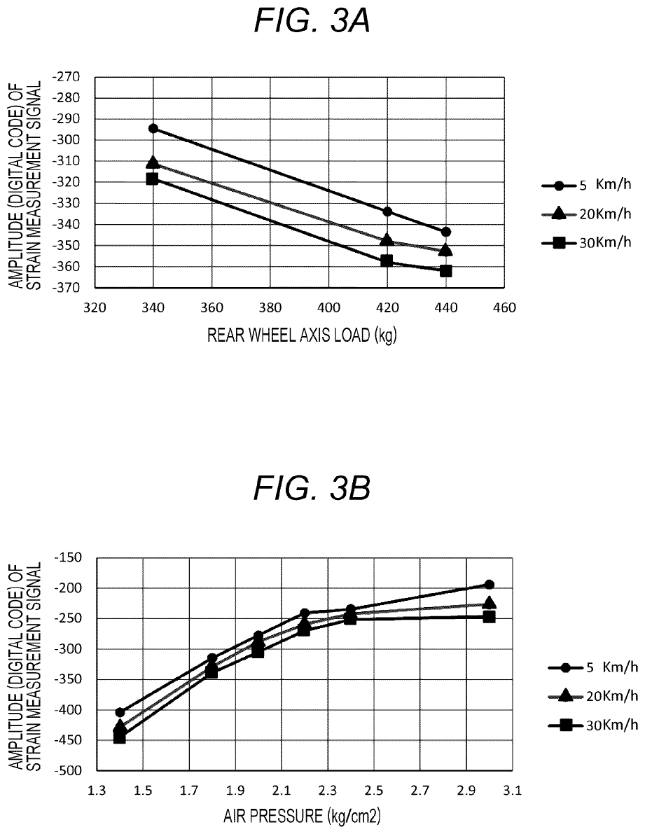

FIG. 3A is an example of data acquired by the calculation unit 15 in S201. Here, a change in the strain measurement signal with respect to a change in the load is exemplified. The calculation unit 15 acquires the relationship between the load acting on the tire and the strain measurement signal value at that time under the reference air pressure, the reference vehicle speed, and the reference temperature. For example, the relationship illustrated in FIG. 3A is acquired for each combination of the vehicle type and the tire type of the vehicle. This relationship may be acquired by actual measurement, or may be acquired by other means such as appropriate simulation. Here, the reference load is set to 340 kg (corresponding to 2 persons on board), the reference air pressure is set to 220 kPa, and the reference temperature is set to 30° C. The reference vehicle speed can be, for example, 7 km/h. A similar relationship may be acquired for vehicle speeds other than the reference vehicle speed. FIG. 3A illustrates an example of it.

The calculation unit 15 similarly acquires the following relationship: (a) relationship representing a change in the strain measurement signal when the tire air pressure changes under the reference vehicle speed, the reference load, and the reference temperature; and (b) relationship representing a change in the strain measurement signal when the vehicle speed changes under the reference load, the reference air pressure, and the reference temperature. As described above, the calculation unit 15 can obtain the variation amount of the strain measurement signal with respect to change of each of the vehicle speed, the load, and the air pressure (sensitivity of the strain sensor 11 to each physical quantity).

FIG. 3B is data indicating a change in the strain measurement signal when the tire air pressure changes under the reference vehicle speed, the reference load, and the reference temperature. Similarly to FIG. 3A, an example is presented in which a similar relationship is acquired for vehicle speeds other than the reference vehicle speed.

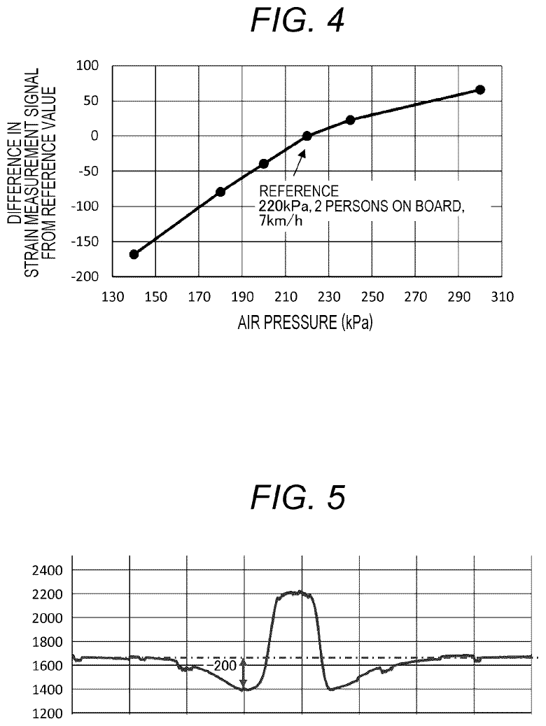

FIG. 4 is an example of data created by the calculation unit 15 in S202. Here, a difference from the reference value of the strain measurement signal with respect to the difference from the reference air pressure is exemplified. In S201, a signal value (reference signal value) of the strain measurement signal output from the strain sensor 11 under the reference vehicle speed, the reference load, the reference air pressure, and the reference temperature can be obtained. In accordance with the result of S201, the calculation unit 15 creates, as in FIG. 4, data representing the relationship representing the change from the reference signal value of the strain measurement signal when the tire air pressure changes from the reference air pressure under the reference vehicle speed, the reference load, and the reference temperature. Therefore, in FIG. 4, when the air pressure is 220 kPa, the strain measurement signal matches the reference signal value (difference=0). The data format may be any format such as a lookup table format.

The calculation unit 15 similarly creates data representing the following relationship: (a) relationship representing a change from the reference signal value of the strain measurement signal when the vehicle speed changes from the reference vehicle speed under the reference load, the reference air pressure, and the reference temperature; and (b) relationship representing a change from the reference signal value of the strain measurement signal when the load changes from the reference load under the reference vehicle speed, the reference air pressure, and the reference temperature. As described above, the calculation unit 15 can obtain the relationship indicating the change from the reference signal value of the strain measurement signal when the vehicle speed, the load, and the air pressure change with respect to the reference vehicle speed, the reference load, and the reference air pressure, respectively.

FIG. 5 is an example of data acquired by the calculation unit 15 in S203. In S202, the change from the reference signal value of the strain measurement signal with respect to the change from the reference air pressure or the like is acquired, but this is a typical value acquired for each combination of the vehicle type and the tire type, and the signal value in the actual vehicle may be different from this. For example, when the actual vehicle is operated under the reference vehicle speed, the reference load, and the reference air pressure, the strain measurement signal may be different from the reference signal value in S202. Therefore, in S203, the difference between the two is corrected.

The signal value of the strain measurement signal can be represented by a signal amplitude. Also in FIGS. 3A to 4, the strain measurement signal is represented by an amplitude. The signal amplitude mentioned here may be any value that represents a fluctuation width of the strain measurement signal. The strain measurement signal has a waveform in which a falling waveform is continuous before and after a rising waveform as in FIG. 5. For example, the amplitude of the first falling waveform can be treated as the amplitude of the strain measurement signal. This is assumed in the following.

In the strain measurement signal illustrated in FIG. 5, in the first falling waveform, the signal value decreases by 200 codes from the steady level (that is, the signal amplitude is −200 codes). On the other hand, in the data acquired in S201 to S202, there is a case where the reference signal value is not −200. Therefore, the calculation unit 15 acquires the difference between the two, and corrects the strain measurement signal to a signal value unique to the vehicle using the difference.

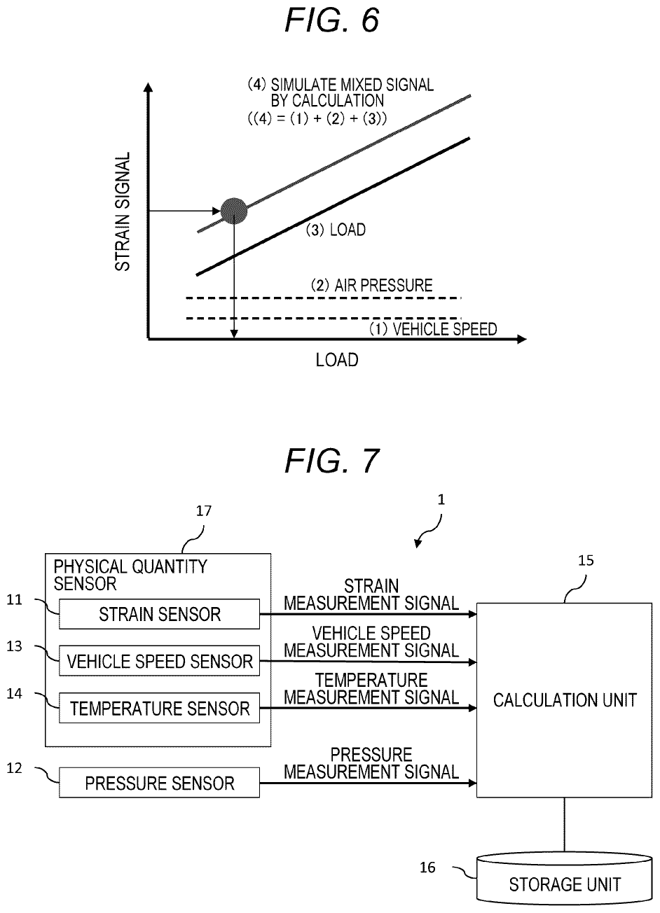

FIG. 6 is a schematic diagram explaining the procedure in which the calculation unit 15 obtains the load in S204. It is originally expected that when a load is applied to the tire, the strain sensor 11 outputs a signal (3) in FIG. 6 in response to the load. However, the strain measurement signal actually output by the strain sensor 11 includes components generated by the vehicle speed and the tire air pressure (signals (1) and (2) in FIG. 6). Therefore, the strain sensor 11 is assumed to output a strain measurement signal (4) obtained by adding up these.

Therefore, by obtaining, through calculation, a signal (signal (4) in FIG. 6) assumed to be output from the strain sensor 11, the calculation unit 15 estimates the load characteristic (signal value corresponding for each load value, i.e., the entire signal (4) illustrated in FIG. 6) of the strain measurement signal (4) including components due to the vehicle speed and the tire air pressure. The calculation unit 15 can obtain the load value by applying the signal value of the actual strain measurement signal obtained from the strain sensor 11 to the estimated load characteristic.

Since the signal (1) is a component generated by the vehicle speed in the strain measurement signal, the difference from the reference signal value of the component generated by the vehicle speed can be obtained by using the difference between the current vehicle speed of the vehicle and the reference vehicle speed and referring to the data (data in which the horizontal axis in FIG. 4 represents the vehicle speed) acquired in S202.

Since the signal (2) is a component generated by the air pressure in the strain measurement signal, the difference from the reference signal value of the component generated by the air pressure can be obtained by using the difference between the current air pressure of the tire and the reference air pressure and referring to the data (data in which the horizontal axis in FIG. 4 represents the air pressure) acquired in S202.

Since the signal (3) is a component generated by the load in the strain measurement signal, the difference from the reference signal value of the component generated by the load can be obtained by using the difference between the current load of the tire and the reference load and referring to the data (data in which the horizontal axis in FIG. 4 represents the load) acquired in S202.

The calculation unit 15 can obtain the signal (4) by adding up the signals (1), (2), and (3) calculated as described above. However, since the reference signal value is data acquired for each combination of the vehicle type and the tire type, there is a possibility of being deviating from the reference signal value unique to the vehicle. Therefore, the calculation unit 15 further adds up the correction values for the vehicle acquired in S203. This makes it possible to reflect the amplitude characteristic of the strain measurement signal in the vehicle on the signal (4) with the data of S202 as a reference.

To summarize the above, the calculation unit 15 calculates in S204 the signal (4) by the following calculation expression:

signal (4)=signal (1) (component generated by difference between reference vehicle speed and current vehicle speed)+signal (2) (component generated by difference between reference air pressure and current air pressure)+signal (3) (component generated by difference between reference load and current load)+correction value unique to the vehicle (correction value obtained in S203)

When acquiring only the signal (3), it is sufficient that the calculation unit 15 calculates the signal (3) by a calculation expression in which components other than the signal (3) in the above calculation expression are transferred to the other side.

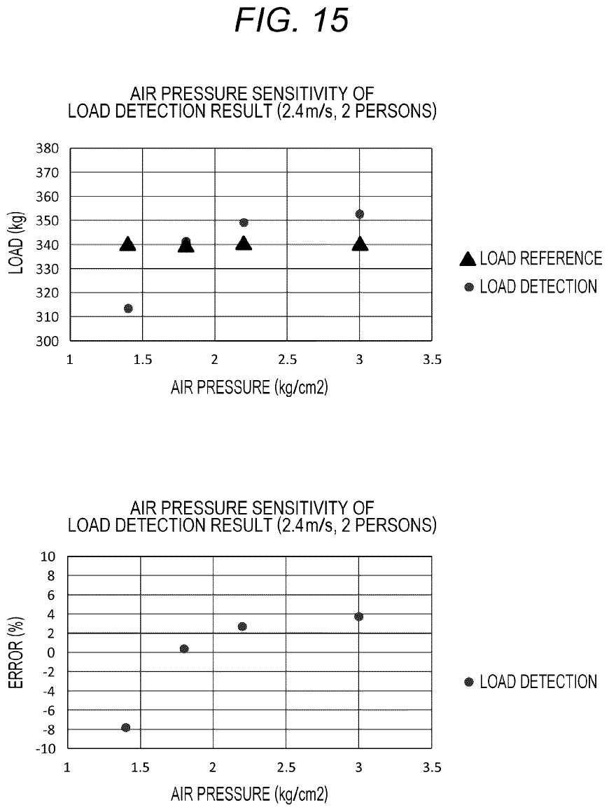

FIG. 15 illustrates an effect of load detection based on a result of simulation using a load extraction model created by MATLAB (registered trademark) Simulink. The upper part in FIG. 15 illustrates the air pressure sensitivity of load detection by model simulation. The lower part in FIG. 15 illustrates the air pressure sensitivity of a load detection error. As a result of calculation using actual vehicle data under the conditions of a vehicle speed of 2.4 m/s (about 9 km/h), 2 persons on board, and 30° C., there is a tendency that the one with lower air pressure is poor in accuracy with respect to a load of actually measured 340 kg and indicates 313 kg, and it has been confirmed that the load estimation error is about 8%.

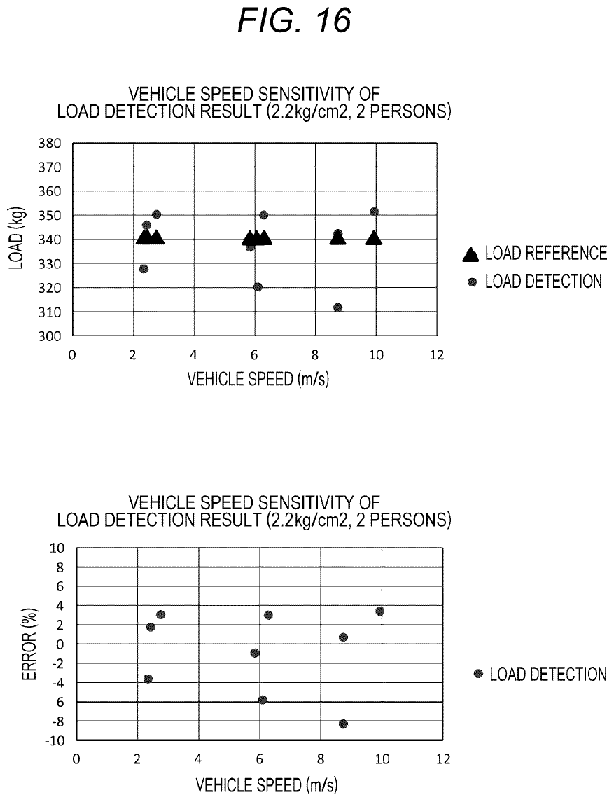

FIG. 16 illustrates vehicle speed sensitivity of load detection. The upper part in FIG. 16 illustrates the vehicle speed sensitivity of load detection by model simulation. The lower part in FIG. 16 illustrates the vehicle speed sensitivity of a load detection error. As a result of calculation using actual vehicle data under the conditions of an air pressure of 220 kPa, 2 persons on board, and 30° C., there is a tendency that the one with faster vehicle speed is poor in accuracy with respect to a load of actually measured 340 kg and indicates 312 kg, and it has been confirmed that the load estimation error is about 8%.

### First Embodiment: Summary

By calculating each component generated by the vehicle speed/load/air pressure in the strain measurement signal, the physical quantity detection device 1 according to the present first embodiment calculates an assumption value (signal (4) in FIG. 6) of the strain measurement signal assumed to be output by the strain sensor 11, and calculates the load by applying the strain measurement signal actually output by the strain sensor 11 to the assumption value. Due to this, even when the strain measurement signal varies due to the influence of the vehicle speed and the tire air pressure, the load applied to the tire can be accurately measured.

The physical quantity detection device 1 according to the present first embodiment calculates the component generated by the air pressure in the strain measurement signal using the data (FIG. 4) describing the amount by which the strain measurement signal deviates from the reference signal value due to the difference between the reference air pressure and the current air pressure. The physical quantity detection device 1 similarly calculates the amount by which the strain measurement signal deviates from the reference signal value due to the difference between the reference vehicle speed and the current vehicle speed. The physical quantity detection device 1 similarly calculates the amount by which the strain measurement signal deviates from the reference signal value due to the difference between the reference load and the current load. Through these processing, the calculation unit 15 can estimate the actual strain measurement signal using the typical reference value for each vehicle type and tire type, and therefore it is possible to suppress the data amount in S202.

The physical quantity detection device 1 according to the present first embodiment acquires a signal amplitude (value corresponding to −200 codes in FIG. 5) unique to the vehicle by operating the actual vehicle under the reference vehicle speed/reference load/reference air pressure, and corrects a difference between the signal amplitude and the reference signal value. This makes it possible to correct an assumption value to a value unique to the vehicle while calculating the assumption value of the strain measurement signal using the typical reference value for each vehicle type and tire type. Therefore, it is possible to obtain an accurate load unique to the vehicle while suppressing the data amount in S202.

### Second Embodiment

FIG. 7 is a block diagram illustrating the configuration of the physical quantity detection device 1 according to the second embodiment of the present invention. The strain sensor 11, the vehicle speed sensor 13, and the temperature sensor 14 may be configured as a single physical quantity sensor 17 that can detect temperature, vehicle speed, and temperature. Other configurations are the same as those of the first embodiment.

### Third Embodiment

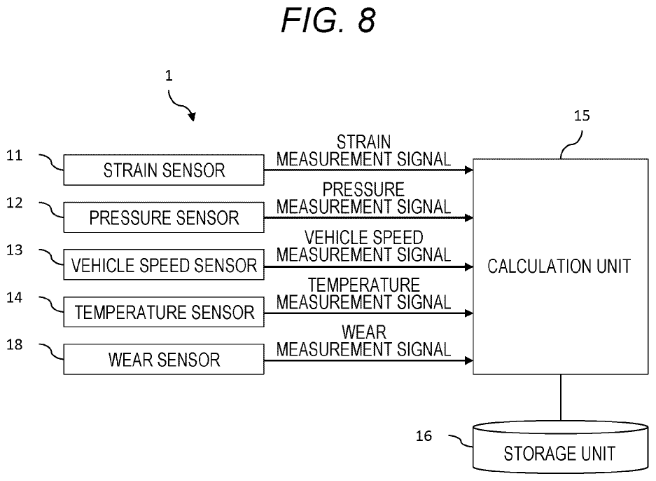

FIG. 8 is a block diagram illustrating the configuration of the physical quantity detection device 1 according to the third embodiment of the present invention. The physical quantity detection device 1 may include a wear sensor 18 in addition to the configuration described in the first embodiment. The wear sensor 18 measures wear of the tire and outputs a wear measurement signal representing the result. Since tire wear also affects the strain measurement signal, the strain measurement signal includes a component caused by the wear similarly to that described in the first embodiment.

The calculation unit 15 acquires the relationship between the wear measurement signal and the strain measurement signal similarly to the first embodiment, and calculates an assumption value of the strain measurement signal using the result. Therefore, the calculation expression becomes as follows. Other configurations are the same as those of the first embodiment:

signal (4)=signal (1) (component generated by difference between reference vehicle speed and current vehicle speed)+signal (2) (component generated by difference between reference air pressure and current air pressure)+signal (3) (component generated by difference between reference load and current load)+correction value unique to the vehicle (correction value obtained in S203)+component generated by difference between reference wear and current wear

### Fourth Embodiment

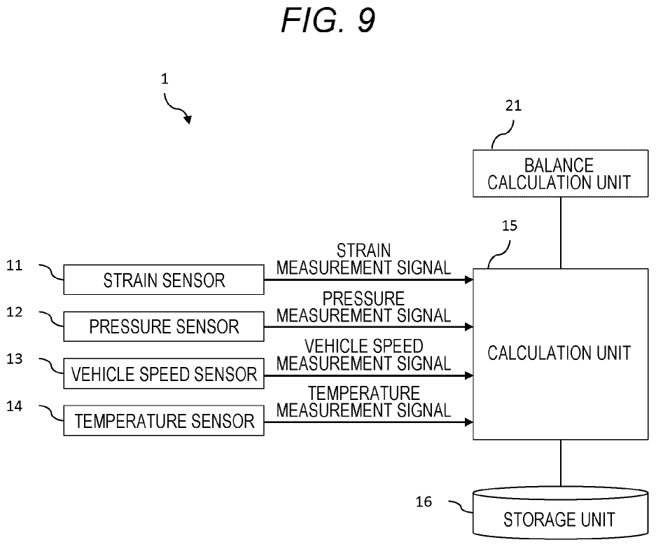

FIG. 9 is a block diagram illustrating the configuration of the physical quantity detection device 1 according to the fourth embodiment of the present invention. In the present fourth embodiment, a balance calculation unit 21 is included in addition to the configuration described in the first embodiment. The balance calculation unit 21 may be configured as a part of the calculation unit 15, may be configured as a functional unit different from the calculation unit 15, or may be configured as a functional unit different from the physical quantity detection device 1.

The calculation unit 15 calculates a load applied to each tire of the vehicle. On the basis of the result, the balance calculation unit 21 calculates the balance of the load with respect to each tire. For example, when an extremely large load is applied to any of the tires as compared to the other tires, an alert to that effect may be output. This can enhance the vehicle safety.

### Fifth Embodiment

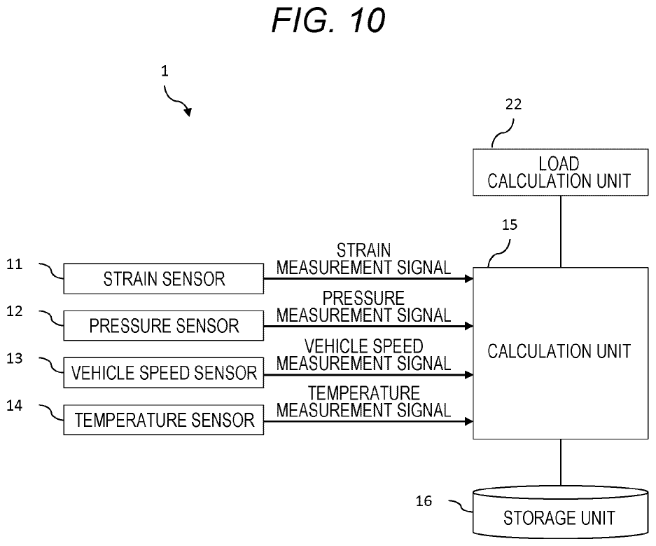

FIG. 10 is a block diagram illustrating the configuration of the physical quantity detection device 1 according to the fifth embodiment of the present invention. In the present fifth embodiment, a load calculation unit 22 is included in addition to the configuration described in the first embodiment. The load calculation unit 22 may be configured as a part of the calculation unit 15, may be configured as a functional unit different from the calculation unit 15, or may be configured as a functional unit different from the physical quantity detection device 1.

The calculation unit 15 calculates a load applied to each tire of the vehicle. On the basis of the result, the load calculation unit 22 calculates the weight of the load loaded on the vehicle or calculates the weight of the load that can be additionally loaded on the vehicle. The load mentioned here is a load excluding the weight of the vehicle itself, and also includes the weight of the passenger. The load calculation unit 22 outputs the load weight, whereby the load loading work can be assisted.

### Modifications of Present Invention

The present invention is not limited to the above-described embodiments, and includes various modifications. For example, the above-described embodiments have been described in detail in order to describe the present invention in an easy-to-understand manner, and are not necessarily limited to those having all the described configurations. It is also possible to replace a part of the configuration of a certain embodiment with the configuration of another embodiment, and it is also possible to add the configuration of another embodiment to the configuration of the certain embodiment. Another configuration can be added to, deleted from, or replaced with a part of the configuration of each embodiment.

In the above embodiments, S201 to S203 may be performed in advance before the load is acquired, and data describing the result may be stored in the storage unit 16.

In the above embodiment, the calculation unit 15 can be configured by hardware such as a circuit device in which the function is implemented, or can be configured by an arithmetic device such as a processor executing software in which the function is implemented. The same applies to the balance calculation unit 21.

### REFERENCE SIGNS LIST

1 physical quantity detection device
11 strain sensor
12 pressure sensor
13 vehicle speed sensor
14 temperature sensor
15 calculation unit
16 storage unit
17 physical quantity sensor
18 wear sensor
21 balance calculation unit
22 load calculation unit

1. A physical quantity detection device that detects a physical quantity acting on a tire, the physical quantity detection device comprising:
a strain sensor that detects strain of the tire generated by a plurality of physical quantities including displacement of the tire and outputs a result of the detection as an actually measured strain amount;
a first sensor that detects an air pressure of the tire among the plurality of physical quantities;
a second sensor that detects a vehicle speed of a vehicle mounted with the tire among the plurality of physical quantities;
a third sensor that detects a temperature of the tire among the plurality of physical quantities;
a calculation unit that calculates a load acting on the tire using the actually measured strain amount, the air pressure, the vehicle speed, and the temperature; and
a storage unit that stores data describing a relationship among the actually measured strain amount, the air pressure, the vehicle speed, the temperature, and the load,
wherein the calculation unit calculates an estimation value of the load by referring to the data using the air pressure, the vehicle speed, the temperature, and the actually measured strain amount.

2. The physical quantity detection device according to claim 1, wherein
by referring to the data, the calculation unit calculates a first assumption value of a strain amount of the tire generated by the air pressure, a second assumption value of the strain amount of the tire generated by the vehicle speed, and a correction value of the actually measured strain amount caused by the temperature,
by referring to the data, the calculation unit calculates, for each value of the load, a third assumption value of the strain amount of the tire generated by the load,
the calculation unit calculates, for each value of the load, an assumption value of the actually measured strain amount by adding up the first assumption value, the second assumption value, and the correction value to the third assumption value calculated for each value of the load, and
the calculation unit calculates an estimation value of the load by applying the actually measured strain amount detected by the strain sensor to the assumption value calculated for each value of the load.

3. The physical quantity detection device according to claim 1, wherein
the data describes a reference strain amount assumed to be detected by the strain sensor when the air pressure is a reference air pressure, the vehicle speed is a reference vehicle speed, and the temperature is a reference temperature,
the data describes a difference between the reference strain amount and the actually measured strain amount is described for each value of a first difference between the reference air pressure and the air pressure, for each value of a second difference between the reference vehicle speed and the vehicle speed, and for each value of a third difference between a reference load and the load,
the calculation unit calculates a first strain amount of the tire generated by the first difference, a second strain amount of the tire generated by the second difference, and a third strain amount of the tire generated by the third difference,
the calculation unit calculates, as a reference value correction amount, a difference between the reference strain amount and an actual strain amount, the actual strain amount being actually detected by the strain sensor when the air pressure is a reference air pressure, the vehicle speed is a reference vehicle speed, and the temperature is a reference temperature,
the calculation unit calculates an assumption value of the actually measured strain amount for each value of the load by adding up the first strain amount, the second strain amount, the third strain amount, the reference strain amount, and the reference value correction amount, and
the calculation unit calculates the estimation value of the load by applying the actually measured strain amount detected by the strain sensor to the assumption value calculated for each value of the load.

4. The physical quantity detection device according to claim 1, wherein
by referring to the data, the calculation unit calculates a first assumption value of a strain amount of the tire generated by the air pressure, a second assumption value of the strain amount of the tire generated by the vehicle speed, and a correction value of the strain amount of the tire generated by the temperature, and
the calculation unit calculates a fourth assumption value of the strain amount of the tire generated by the load, by subtracting the first assumption value, the second assumption value, and the correction value from the actually measured strain amount.

5. The physical quantity detection device according to claim 1, wherein the strain sensor, the second sensor, and the third sensor are configured by one physical quantity sensor that detects the actually measured strain amount, the vehicle speed, and the temperature.

6. The physical quantity detection device according to claim 1, further comprising a fourth sensor that detects wear of the tire,
wherein
the data describes a relationship among the actually measured strain amount, the air pressure, the vehicle speed, the temperature, the load, and the wear, and
the calculation unit calculates an estimation value of the load by referring to the data using the air pressure, the vehicle speed, the temperature, the wear, and the actually measured strain amount.

7. The physical quantity detection device according to claim 1, wherein
the calculation unit calculates the load acting on each tire mounted on each wheel of the vehicle, and
the calculation unit calculates a balance of a load acting on the each wheel by using the load acting on the each tire.

8. The physical quantity detection device according to claim 1, wherein using the load, the calculation unit calculates a weight of a load loaded on the vehicle mounted with the tire or a weight of a load that can be additionally loaded.
